(19) United States
(12) Patent Application Publication
(10) Pub. No.: US 2025/0227413 A1
(43) Pub. Date: Jul. 10, 2025

(54) SPEAKER OUTPUT CHARACTERISTIC CORRECTION SYSTEM AND ACOUSTIC SYSTEM

(71) Applicant: ALPS ALPINE CO., LTD., Tokyo (JP)

(72) Inventor: Yuji SAITO, Fukushima (JP)

(21) Appl. No.: 18/984,077

(22) Filed: Dec. 17, 2024

(30) Foreign Application Priority Data
Jan. 9, 2024 (JP) 2024-001246

(51) Int. Cl. H04R 3/08; H04R 3/00; H04R 9/02; H04R 9/06; H04R 29/00

(52) U.S. Cl. CPC H04R 3/08; H04R 3/002; H04R 29/003; H04R 9/025; H04R 9/06

(57) ABSTRACT

A speaker output characteristic correction system for correcting an output characteristic of a speaker with respect to an audio signal output from a sound source device, includes a filter configured to supply to the speaker an output obtained by applying a set filter transfer characteristic to the audio signal output from the sound source device, a transfer characteristic setting unit configured to set a filter transfer characteristic of the filter, and a displacement detection unit configured to detect a displacement of a vibration of the speaker.

The present application is based on and claims priority to Japanese patent application No. 2024-001246 filed on Jan. 9, 2024, with the Japanese Patent Office, the entire contents of which are hereby incorporated by reference.

### BACKGROUND OF THE INVENTION

### 1. Field of the Invention

The present invention relates to a technology for correcting an output characteristic of a speaker.

### 2. Description of the Related Art

As a technology for correcting an output characteristic of a speaker, there is known an acoustic reproduction device that adjusts the output characteristic of the speaker to a desired characteristic by performing an experiment in advance to calculate a transfer characteristic from the speaker to a sound receiving position by placing a microphone at the sound receiving position, and convoluting an inverse characteristic of the transfer characteristic calculated through experiment and a required transfer characteristic into an audio signal and outputting it to the speaker (e.g., Patent Literature (PTL) 1).

As a technology related to the present application, there is known a technology which provides a sensor for detecting displacement of a vibration of the speaker, and calculates and updates each parameter of an equivalent circuit of the speaker from a response of the displacement detected by the sensor to a test signal output to the speaker (e.g., PTL 2).

In the case of speakers such as woofers and subwoofers, whose main role is low-frequency reproduction, it is generally necessary to increase a diameter of the speaker in order to increase a fundamental sound pressure level of a low-frequency output. However, since increasing the diameter of the speaker involves an increase in size, weight, and cost, there are cases that increasing the diameter may not be applicable. Therefore, instead of enlarging the diameter of the speaker, it is also conceivable to increase a basic sound pressure level in a low range to be outputted by applying a technology in which the inverse characteristics of the transfer characteristics from the speaker to the sound receiving position and the required transfer characteristics are convoluted into an audio signal and outputted to the speaker, but in this technology, since it is necessary to perform an experiment in advance in which a microphone is placed at the sound receiving position in order to find the transfer characteristics of the speaker, it is not easy to accurately calculate the inverse characteristics of the transfer characteristics for each speaker with different characteristics or errors in the characteristics. Moreover, it is not possible to cope with aging-related changes in the transfer characteristics of the speaker.

Therefore, it is an object of the present invention to correct the output characteristics of the speaker to a target output characteristic with high accuracy in accordance with an actual transfer characteristic of each speaker.

### CITATION LIST

### Patent Literature

[PTL 1] Japanese Laid-Open Patent Publication No. 2010-21982
[PTL 2] Japanese Laid-Open Patent Publication No. 2023-125746

### SUMMARY OF THE INVENTION

A speaker output characteristic correction system for correcting an output characteristic of a speaker with respect to an audio signal output from a sound source device, includes a filter configured to supply to the speaker an output obtained by applying a set filter transfer characteristic to the audio signal output from the sound source device, a transfer characteristic setting unit configured to set a filter transfer characteristic of the filter, and a displacement detection unit configured to detect a displacement of a vibration of the speaker, wherein the transfer characteristic setting unit is configured to set a transfer characteristic realizing an inverse transmission characteristic and a target transmission characteristic as the filter transfer characteristic of the filter, the inverse transmission characteristic being an inverse of a base transmission characteristic, and the base transmission characteristic being a transmission characteristic from the audio signal to an acoustic signal value that is observed at a sound receiving point when the audio signal output from the sound source device is directly used as an output of the filter, the sound receiving point being predetermined, wherein the target transfer characteristic is such that an acoustic signal value having a target acoustic signal characteristic is observed at the sound receiving point by using the target transfer characteristic as a transfer characteristic from the audio signal to an acoustic signal value at the sound receiving point when the audio signal output from the sound source device is directly used as an output of the filter, and wherein the transfer characteristic setting unit is configured to determine a parameter of an equivalent circuit of the speaker based on a response of the displacement detected by the displacement detection unit to the audio signal output from the sound source device, calculate the inverse transfer characteristic according to the equivalent circuit having the determined parameter, and set a transfer characteristic realizing the calculated inverse transfer characteristic and the target transfer characteristic as the filter transfer characteristic of the filter.

### BRIEF DESCRIPTION OF THE DRAWINGS

FIG. 1 is a drawing illustrating a configuration of an acoustic system according to an embodiment of the present invention;

FIG. 2A is a drawing illustrating a configuration of a speaker;

FIG. 2B is s a drawing illustrating a configuration of displacement detection according to the embodiment of the present invention;

FIG. 3 is a drawing illustrating a model of a control filter according to the embodiment of the present invention;

FIG. 4 is a drawing illustrating an equivalent circuit of a speaker;

FIG. 5 is a drawing illustrating a model used for calculating sound pressure;

FIG. 6 is a drawing illustrating an example of impedance of a speaker calculated according to the embodiment of the present invention; and

FIG. 7 is a drawing illustrating an effect of the embodiment of the present invention.

### DESCRIPTION OF THE PREFERRED EMBODIMENTS

In the output characteristic speaker correction system further including a transfer characteristic updating unit configured to update the filter transfer characteristic of the filter, the transfer characteristic updating unit may be configured to detect a change in the parameter of the equivalent circuit of the speaker based on the displacement detected by the displacement detection unit, update the inverse transfer characteristic according to the detected changed parameter, and update the filter transfer characteristic of the filter to the transfer characteristic realizing the updated inverse transfer characteristic and the target transfer characteristic.

The speaker output characteristic correction system may further include a transfer characteristic updating unit configured to update the filter transfer characteristic of the filter, and an input detection unit configured to detect an input current and an input voltage of the speaker, wherein the transfer characteristic updating unit is configured to detect a change in the parameter of the equivalent circuit of the speaker based on an impedance of the speaker found from the input current and the input voltage detected by the input detection unit, update the inverse transfer characteristic according to the equivalent circuit having a detected changed parameter, and update the filter transfer characteristic of filter the to the transfer characteristic realizing the updated inverse transfer characteristic and the target transfer characteristic.

Further, in order to achieve the object, the present invention provides a speaker output characteristic correction system for correcting an output characteristic of a speaker with respect to an audio signal output from a sound source device, including a filter configured to supply to the speaker an output obtained by applying a set filter transfer characteristic to the audio signal output from the sound source device, a transfer characteristic updating unit configured to update a filter transfer characteristic of the filter, and a displacement detection unit configured to detect a displacement of a vibration of the speaker. Here, the filter transfer characteristic is a transfer characteristic realizing an inverse transmission characteristic and a target transmission characteristic, the inverse transmission characteristic being an inverse of a base transmission characteristic, and the base transmission characteristic being a transmission characteristic from the audio signal to an acoustic signal value that is observed at a sound receiving point when the audio signal output from the sound source device is directly used as an output of the filter, the sound receiving point being predetermined, the target transfer characteristic is such that the acoustic signal value having a target acoustic signal characteristic is observed at the sound receiving point by using the target transfer characteristic as a transfer characteristic from the audio signal to an acoustic signal value at the sound receiving point when the audio signal output from the sound source device is directly used as an output of the filter, and the transfer characteristic updating unit is configured to detect a change in a parameter of an equivalent circuit of the speaker based on the displacement detected by the displacement detection unit, update the inverse transfer characteristic according to the equivalent circuit having a detected changed parameter, and update the filter transfer characteristic of the filter to the transfer characteristic realizing the updated inverse transfer characteristic and the target transfer characteristic.

Further, in order to achieve the object, the present invention provides a speaker output characteristic correction system for correcting an output characteristic of a speaker with respect to an audio signal output from a sound source device, including a filter configured to supply to the speaker an output obtained by applying a set filter transfer characteristic to the audio signal output from the sound source device, a transfer characteristic updating unit configured to update a filter transfer characteristic of the filter, and an input detection unit configured to detect an input current and an input voltage. Here, the filter transfer characteristic is a transfer characteristic realizing an inverse transmission characteristic and a target transmission characteristic, the inverse transmission characteristic being an inverse of a base transmission characteristic, and the base transmission characteristic being a transmission characteristic from the audio signal to an acoustic signal value that is observed at a sound receiving point when the audio signal output from the sound source device is directly used as an output of the filter, the sound receiving point being predetermined, the target transfer characteristic is such that an acoustic signal value having a target acoustic signal characteristic is observed at the sound receiving point by using the target transfer characteristic as a transfer characteristic from the audio signal to an acoustic signal value at the sound receiving point when the audio signal output from the sound source device is directly used as an output of the filter, and the transfer characteristic updating unit is configured to detect a change in a parameter of an equivalent circuit of the speaker based on an impedance of the speaker found from the input current and the input voltage detected by the input detection unit, update the inverse transfer characteristic according to the equivalent circuit having the detected changed parameter, and update the filter transfer characteristic of the filter to the transfer characteristic realizing the updated inverse transfer characteristic and the target transfer characteristic.

In the output characteristic correction system, the target acoustic signal characteristic may be a sound pressure level frequency characteristic, and the acoustic signal value is a sound pressure level. Moreover, the base transfer characteristic, which is the transfer characteristic from the audio signal to the sound pressure level that is the acoustic signal value at the sound receiving point, is a transfer characteristic determined by a function configured to determine a relation between the transfer characteristic from the audio signal to the displacement of the vibration of the speaker found by the equivalent circuit of the speaker and the displacement of the vibration of the speaker and the sound pressure level at the sound receiving point.

In this case, the sound pressure level frequency characteristic, which is the target acoustic signal characteristic, may be a frequency characteristic in which the sound pressure level at the sound receiving point is larger than when the audio signal output from the sound source device is directly used as an output of a filter in a low range. Moreover, the transfer characteristic setting unit may be configured to calculate the target transfer characteristic by using the equivalent circuit obtained by modifying the equivalent circuit having the determined parameter so as to reduce an impedance, as the equivalent circuit of a virtual speaker in which an acoustic signal value having the target acoustic signal characteristic is obtained at the sound receiving point, and set a transfer characteristic realizing the calculated inverse transfer characteristic and the target transfer characteristic as the filter transfer characteristic of the filter.

The present invention further provides an acoustic system including the speaker output characteristic correction system, the speaker, and the sound source device. According to the above-described speaker output characteristic correction system or acoustic system of a speaker equipped with transfer characteristic setting a unit, the equivalent circuit of the speaker is calculated so as to conform to the measured displacement of the vibration of the speaker, and the inverse transfer characteristic G⁻ is set so as to follow the calculated equivalent circuit. Therefore, the correction of the output characteristic of the speaker to the target output characteristic can be made to conform to the actual transfer characteristic of the individual speaker, and as a result, the correction can be made with high accuracy.

Moreover, according to the above-described output characteristic correction system or acoustic system of a speaker equipped with a transfer characteristic updating unit, the equivalent circuit of the speaker can be updated so as to conform to the measured displacement of the vibration of the speaker and the impedance of the speaker, and the inverse transfer characteristic G⁻ can be updated so as to follow the updated equivalent circuit. Therefore, the correction of the output characteristic of the speaker to the target output characteristic can be made to conform to the actual transfer characteristic of the speaker at each point in time even when the transfer characteristic of the speaker changes with age, and as a result, the correction can be made with high accuracy.

As described above, according to the present invention, the correction of the output characteristic of the speaker to the target output characteristic can be made with high accuracy in accordance with the actual transfer characteristic of the individual speaker.

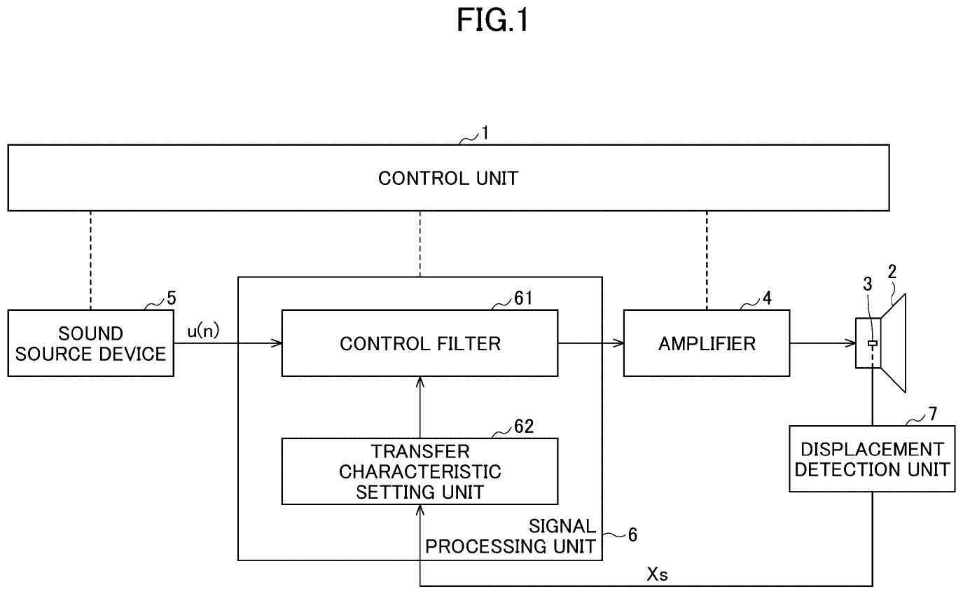

In the following, embodiments of the present invention will be described. FIG. 1 is a drawing illustrating a configuration of an acoustic system according to the present embodiment. As shown in the figure, the acoustic system includes a control unit 1, a speaker 2, a sensor 3 provided in the speaker 2, an amplifier 4, a sound source device 5 for outputting a sound source output signal u(n) which is an audio signal, a signal processing unit 6, and a displacement detection unit 7 for measuring the displacement Xs of the vibration of the speaker 2 from the output of the sensor 3. The signal processing unit 6 includes a control filter 61 and a transfer characteristic setting unit 62 for setting and updating the transfer characteristic (filter coefficient) of the control filter 61. Here, the signal processing unit 6 can be configured using a DSP or MCU, and in this case, the control filter 61 and the transfer characteristic setting unit 62 are functional units implemented by executing software. Here, the control unit 1 is an electronic circuit, such as a CPU, FPGA, or ASIC, that executes various processes described in the present application specification by executing instruction codes stored in memory or by designing circuits for special applications.

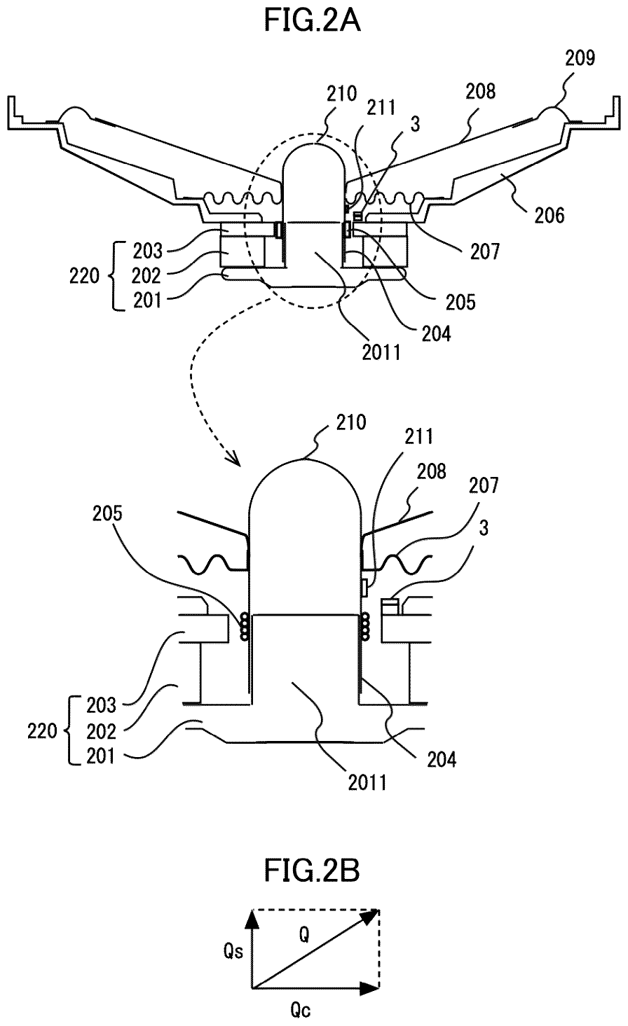

The sound source output signal u(n) output from the sound source device 5 is output to the amplifier 4 as an intermediate output signal through the control filter 61 of the signal processing unit 6, and the amplifier 4 amplifies the intermediate output signal at a predetermined gain to generate an amplifier output signal, and drives the speaker 2 with the amplifier output signal. Next, FIG. 2A shows the configuration of the speaker 2. As shown in the figure, the speaker 2 has a yoke 201, a magnet 202, a top plate 203, a voice coil bobbin 204, a voice coil 205, a frame 206, a damper 207, a diaphragm 208, an edge 209, a dust cap 210, and a displacement detection magnet 211. When the upper portion is a front of the speaker 2 and the lower portion is a rear of the speaker 2 in the figure, the yoke 201 has a convex portion 2011 projecting forward in the center, an annular magnet 202 is provided on an outer periphery of the convex portion 2011, and an annular top plate 203 is provided on the magnet 202. The top plate 203 is composed of a conductive member such as iron. The yoke 201, the magnet 202, and the top plate 203 form a magnetic circuit 220.

The voice coil bobbin 204 has a hollow tubular shape, and the voice coil 205 to which a signal from the amplifier 4 is applied is wound around the outer periphery. The convex portion 2011 of the yoke 201 is inserted from the rear into the hollow of the voice coil bobbin 204 so that the voice coil bobbin 204 can move back and forth with respect to the yoke 201, and the voice coil 205 is arranged between the convex portion 2011 of the yoke 201 and the top plate 203 at a position where a magnetic flux generated between inner peripheral ends of the top plate 203 by the magnetic circuit 220 passes.

The diaphragm 208 has a shape similar to a lateral surface of a truncated cone whose height direction is approximately a longitudinal direction of the speaker 2, and its outer peripheral end is connected to the front end of the frame 206 by the edge 209. The inner peripheral end of the diaphragm 208 is fixed to the front end of the voice coil bobbin 204.

In this configuration of the speaker 2, when an output signal from the amplifier 4 is applied to the voice coil 205, the voice coil bobbin 204 oscillates back and forth according to an amplitude of the output signal by an electromagnetic action of the magnetic flux generated from the magnetic circuit 220 and the signal flowing through the voice coil 205. When the voice coil bobbin 204 oscillates, the diaphragm 208 connected to the voice coil bobbin 204 oscillates, and a sound corresponding to the signal from the amplifier 4 is generated.

The displacement detection magnet 211 is fixed to the outer peripheral surface of the voice coil bobbin 204 so as to move together with the voice coil bobbin 204, and generates the magnetic flux in a direction orthogonal to the magnetic flux generated by the magnetic circuit 220. Here, the above-described sensor 3 is fixed at a position close to the displacement detection magnet 211 in a non-vibration of the speaker 2 such as the top plate 203. The sensor 3 is a magnetic angle sensor and, as shown in FIG. 2B, detects and outputs an arctangent Qs/Qc of an angle of a resultant vector Q of the magnetic flux vector Qc acting from the magnetic circuit 220 and the magnetic flux vector Qs acting from the displacement detection magnet 211 as the magnetic angle. Since the magnetic flux vector generated by the displacement detection magnet 211 acting on the sensor 3 changes due to the displacement of the voice coil bobbin 204, the magnetic angle is a value in accordance with the displacement amount of the voice coil bobbin 204.

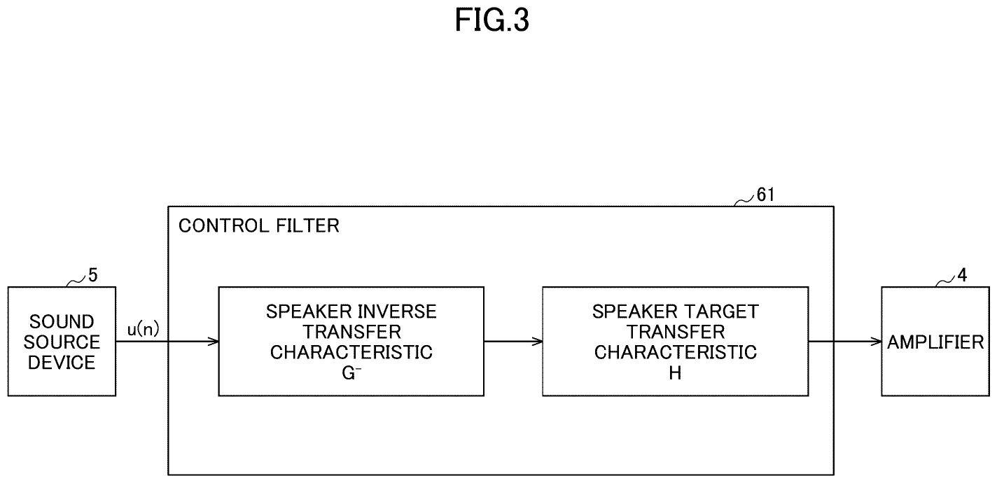

Then, as shown in FIG. 1, the displacement detection unit 7 measures the displacement of the vibration of the speaker 2 from the output of the sensor 3 and outputs the displacement Xs to the transfer characteristic setting unit 62. Here, although not shown, the speaker 2 is provided with an input detection unit that detects input voltage and input current (current flowing through the speaker 2), and the input detection unit outputs the detected information of the input voltage and input current to the transfer characteristic setting unit 62. Next, FIG. 3 shows a block diagram equivalent to the filter processing performed by the control filter 61. As shown in the figure, the control filter 61 performs a processing equivalent to applying the inverse transfer characteristic G⁻ of the transfer characteristic from the speaker input to a predetermined sound receiving point M to the sound source output signal u(n) output by the sound source device 5, and applying the target transfer characteristic H of the transfer characteristic from the speaker input to the sound receiving point M, in which the frequency characteristic of the sound pressure level at the sound receiving point M becomes the target frequency characteristic, to the sound source output signal u(n) to which the inverse transfer characteristic G⁻ is applied, and outputting the sound source output signal u(n) as the intermediate output signal to the amplifier 4.

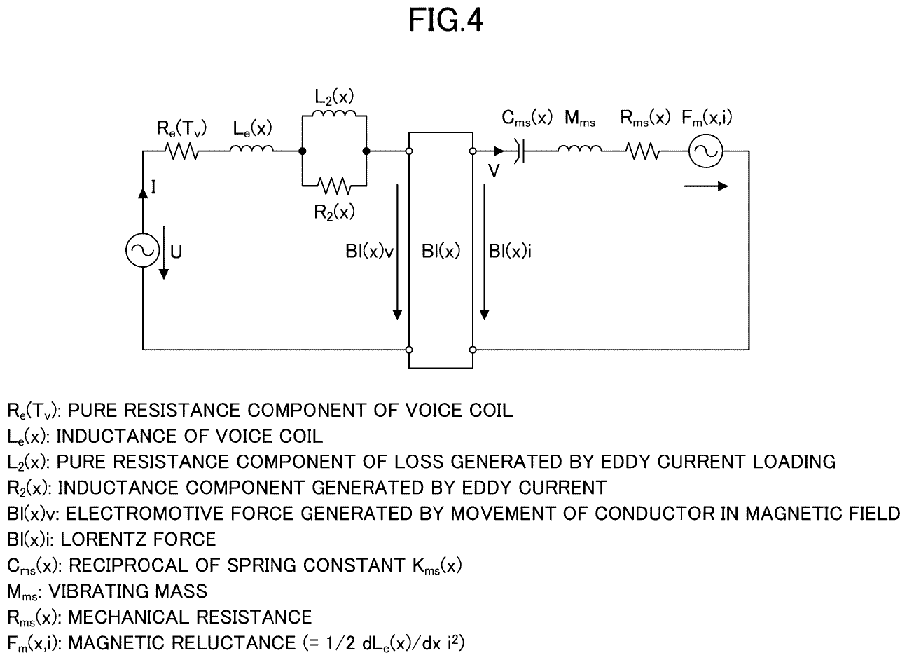

However, the control filter 61 may actually be configured as a single filter in which the transfer characteristic combining the inverse transfer characteristic G⁻ and the target transfer characteristic H is set. Next, transfer the characteristic setting unit 62 performs an initial setting and update of the transfer characteristic of the control filter 61. First, the initial setting of the transfer characteristic of the control filter 61 performed by the transfer characteristic setting unit 62 will be described. An execution of this initial setting is controlled by the control unit 1 at a time of pre-shipment adjustment of the sound system and at a time of starting actual operation. FIG. 4 shows a well-known equivalent circuit of the speaker 2 using TS (Thiele Small) parameters. An equation is derived from this circuit, equivalent then a Laplace transformation is performed, and the displacement x(n) of the vibration of the speaker 2 relative to the input audio signal u(n) is expressed by equation 1 using a backward Euler method for discrete approximation.

$$x ( n ) = - {a}_{1} x ( n - 1 ) - {a}_{2} x ( n - 2 ) - {a}_{3} x ( n - 3 ) + {b}_{0} u ( n ) \qquad Equation 1$$

$$a 0 = {R}_{e} {K}_{ms} + Fs ( {R}_{e} {R}_{ms} + {L}_{e} {K}_{ms} + {Bl}^{2} ) + {Fs}^{2} ( {R}_{e} {M}_{ms} + {L}_{e} {R}_{ms} ) + {Fs}^{3} ( {M}_{ms} {L}_{e} )$$

$${a}_{1} = \{ - Fs ( {R}_{e} {R}_{ms} + {L}_{e} {K}_{ms} + {Bl}^{2} ) - 2 {Fs}^{2} ( {R}_{e} {M}_{ms} + {L}_{e} {R}_{ms} ) - 3 {Fs}^{3} ( {M}_{ms} {L}_{e} ) \} / {a}_{0}$$

$${a}_{2} = \{ {Fs}^{2} ( {R}_{e} {M}_{ms} + {L}_{e} {R}_{ms} ) + 3 {Fs}^{3} ( {M}_{ms} {L}_{e} ) \} / {a}_{0}$$

$${a}_{3} = - {Fs}^{3} ( {M}_{ms} {L}_{e} ) / {a}_{0}$$

$${b}_{0} = Bl / {a}_{0}$$

Fs is a sampling frequency.

The inverse function of Equation 1 is Equation 2.

$$x ( n ) = \{ {a}_{0} u ( n ) + {a}_{1} x ( n - 1 ) + {a}_{2} x ( n - 2 ) + {a}_{3} x ( n - 3 ) \} / {b}_{0} \qquad Equation 2$$

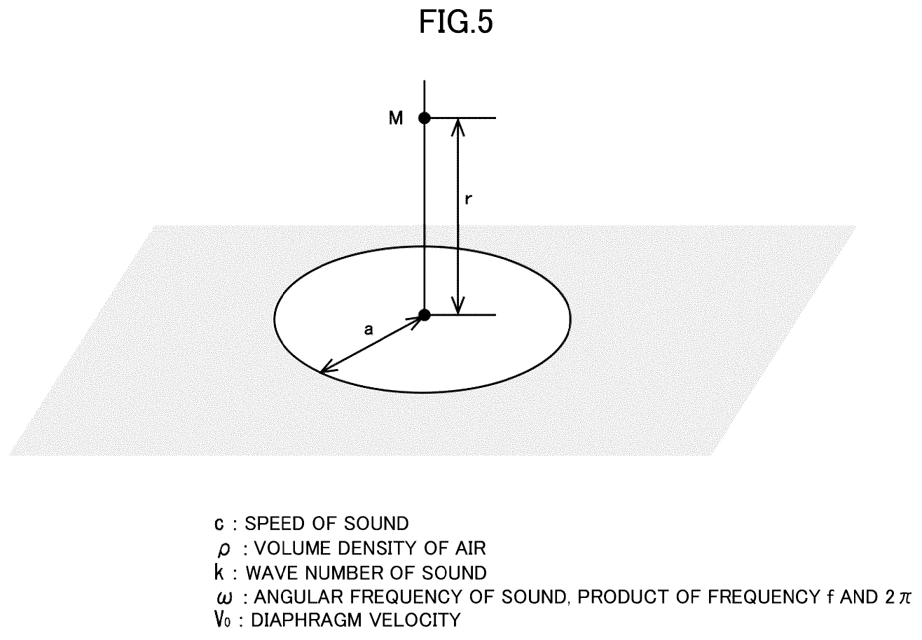

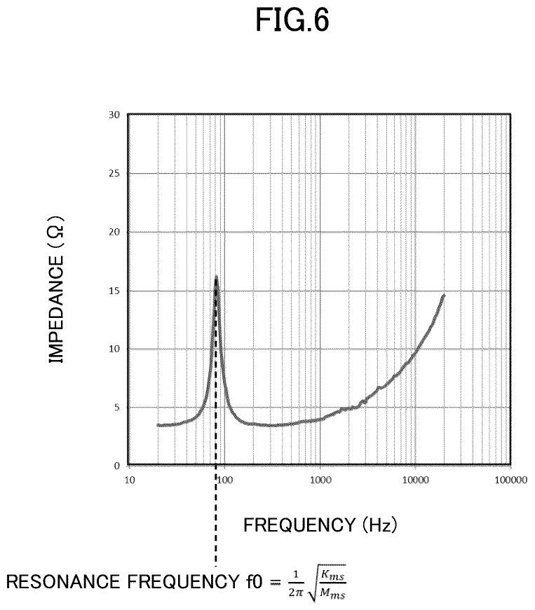

An absolute sound pressure |P| at the sound receiving point M located r away from the diaphragm on the central axis of the diaphragm of radius a with infinite baffle shown in FIG. 5 is found from a Rayleigh integral with d=r/a by Equation 3 or Equation 4, which approximates Equation 3. Where, U in Equation 4 is volume velocity and U=na²V₀.

$$[ Math 1 ]$$

$$\vert P \vert = 2 ρ {cV}_{0} sin \{ \frac{ka}{2} ( \sqrt{{d}^{2} + 1} - d ) \} \qquad Equation 3$$

$$[ Math 2 ]$$

$$\vert P \vert = \frac{ωρ u}{2 π r} \qquad Equation 4$$

Therefore, since the diaphragm velocity V₀ in Equation 3 or 4 is a function of x(n) in Equation 1, the transfer characteristic setting unit 62 finds values of each parameter in Equation 1, sets a predetermined position on the center axis of the speaker 2 to the sound receiving point M, and sets a diaphragm radius a so as to conform to a radius of the speaker 2. Thus, the transfer characteristic G from the input U(n) of the speaker 2 to the sound pressure absolute value |P| at the sound receiving point M can be found from Equation 1 and Equation 3 or Equation 4.

From the found transfer characteristic G, the inverse transfer characteristic G⁻ can be calculated using the inverse function of Equation 2 or the like. The transfer characteristic setting unit 62 can calculate the values of each parameter in Equation 1 based on the displacement Xs of the vibration of the speaker 2 detected by the displacement detection unit 7. That is, for example, in the transfer characteristic setting unit 62, reference data in which the correspondence between a theoretical value of each parameter and a response of the displacement of the speaker 2 to a predetermined (e.g., test signal frequency sweep signal) is registered in the reference data for a plurality of error values slightly different from each other within the manufacturing tolerance of the speaker 2, when there is error with respect to the error value in each dimension of the speaker 2, is stored in advance.

Then, in the transfer characteristic setting unit 62, with the control filter 61 set to output the sound source output signal u(n) as it is, the sound source device 5 outputs the test signal, and the response of the displacement Xs of the vibration of the speaker 2 to the test signal detected by the displacement detection unit 7 is recorded. Then, as the value of each parameter in Equation 1, the theoretical value of each parameter in which the correspondence with the response of the speaker 2 which is most consistent with the recorded response of the displacement registered in the reference data is calculated.

However, in the initial setting of the transfer characteristics of the control filter 61, as the value of each parameter in Equation 1, the values of the parameters found and set in advance from design specifications of the speaker 2, or the values of the parameters found and set in advance by measurement may be used. Next, as the target transfer characteristic H, the transfer characteristic from the input U(n) of the speaker 2 to the sound pressure absolute value |P| of the sound receiving point M, which is found in advance so that the frequency characteristic of the sound pressure absolute value the |P| corresponds to target frequency characteristic as much as possible, is set in advance. The target transfer characteristic H may be found by calculation, simulation, experiment, or the like. Alternatively, as the target transfer characteristic H, the transfer characteristic G of another type of speaker having a good frequency characteristic of the sound pressure absolute value |P|, or the transfer characteristic G found by adjusting the transfer characteristic G of the other type of speaker may be used. In this case, the transfer characteristic G of the other type of speaker may be calculated in the same manner as the transfer characteristic G of the speaker 2 described above.

Alternatively, as the target transfer characteristic H, the transfer characteristic G of the speaker 2 calculated after reducing a spring constant Kₘₛ of Equation 1 may be used. By reducing Kₘₛ, a resonance frequency f0 represented by Equation can be shifted to the low-frequency range.

$$[ Math 3 ]$$

$$Resonance Frequency f 0 = \frac{1}{2 π} \sqrt{\frac{{K}_{ms}}{{M}_{ms}}} \qquad Equation 5$$

For example, when Kₘₛ is ¼, the resonance frequency f0 is ½. Since the output sound pressure level of the speaker 2 is greatly reduced in the lower frequency range than the resonance frequency f0, when the target frequency characteristic of the absolute sound pressure value |P| a frequency is characteristic that increases the sound pressure level of the speaker 2 in the lower frequency range, the reduction of the sound pressure level in the lower frequency range can be suppressed by moving the resonance frequency f0 to the lower frequency range using the target transfer characteristic H.

The transfer characteristic setting unit 62 sets the transfer characteristic that is a combination (convolution) of the inverse transfer characteristic G⁻ and the target transfer characteristic H thus found as the transfer characteristic of the control filter 61, thereby initializing the transfer characteristic of the control filter 61. Next, the update of the transfer characteristic of the control filter 61 performed by the transfer characteristic setting unit 62 will be described. This update is periodically controlled, for example, by the control unit 1. In the update of the transfer characteristic of the control filter 61, the inverse transfer characteristic G⁻ is updated so as to conform to the change of the actual characteristic of the speaker 2, and the transfer characteristic of the control filter 61 is updated to the transfer characteristic that is a combination (convolution) of the inverse transfer characteristic G⁻ and the target transfer characteristic H after the update. The update of the inverse transfer characteristic G⁻ is performed by updating the parameters of equation 1 so as to follow the change of the actual characteristic of the speaker 2, and calculating the inverse transfer characteristic G⁻ using the updated parameters. The update of the parameter does not necessarily have to be performed for all the parameters of equation 1, but may be performed only for some parameters, for example, parameters whose values are expected to change over time. For example, to update the parameter Kₘₛ, Whose value changes with aging are relatively remarkable, it can be done as follows. That is, from the equivalent circuit shown in FIG. 4, if an inductance having a small effect in the low range is ignored, Equations 6 and 7 can be obtained, where i(t) is a current.

$$[ Math 4 ]$$

$${R}_{e} i ( t ) + Bl \frac{dx}{dt} = u ( t ) \qquad Equation 6$$

$$[ Math 5 ]$$

$${K}_{ms} x ( t ) + {M}_{ms} \frac{{d}^{2} x}{{dt}^{2}} + {R}_{ms} \frac{dx}{dt} = Bli ( t ) \qquad Equation 7$$

When the current i(t) is removed from these two equations by substitution, Equation 8 can be obtained.

$$[ Math 6 ]$$

$${K}_{ms} x ( t ) + ( {R}_{ms} + \frac{{Bl}^{2}}{{R}_{e}} ) \frac{dx}{dt} + {M}_{ms} \frac{{d}^{2} x}{{dt}^{2}} = \frac{Bl}{{R}_{e}} u ( t ) \qquad Equation 8$$

Therefore, the transfer characteristic setting unit 62 calculates Kₘₛ according to Equation 8 based on the displacement Xs of the vibration detected by the displacement detection unit 7, its derivative, and the second derivative using the value at the time of initial setting as the parameters of Equation 1 other than Kₘₛ. If the calculated Kₘₛ changes more than the allowable value, the parameter Kₘₛ is updated.

When the parameter Kₘₛ is to be updated, the Kₘₛ can be updated as follows. That is, the resonance frequency f0 at which the peak of the impedance z=u/i of the speaker 2 is found by using the input current as i and the input voltage of the speaker 2 as v, detected by the input detection unit described above, is detected. Then, according to Equation 5 described above,

$${K}_{ms} = {( 2 π fs )}^{2} {M}_{ms}$$

is calculated using Mₘₛ, and if the calculated Kₘₛ changes more than the allowable value, the parameter Kₘₛ is updated.

In updating the parameters, the parameters may be updated according to an accumulated amount of states related to the parameter of the speaker 2. That is, for example, a change amount table in which the correspondence between the accumulated amount of the states related to the parameters of Equation 1 and the change amount of the dimensions of the speaker 2 is registered is stored in advance, the accumulated amount of the states is managed, the change amount of the dimensions of the speaker 2 corresponding to the accumulated amount of the current states is acquired from the change amount table, the value of the current dimensions of the speaker 2 is found, and the parameters may be updated so as to correspond to the found values of the dimensions.

For example, a temperature that causes demagnetization of a magnet can be used as a state to manage a storage amount. In this case, the correspondence between the storage amount of the temperature that causes demagnetization of the magnet and the amount of demagnetization of the magnet is registered in the change amount table in advance. The temperature is detected and recorded by attaching a temperature sensor to the magnet, or the temperature of the magnet is calculated and recorded from heat propagation of Joule heat generated by the voice coil found from the input voltage and the input current of the speaker 2 to the magnet.

Then, from the recorded history of the temperature of the magnet, the storage amount of the temperature that causes demagnetization of the magnet (e.g., the time integral of temperature that causes demagnetization) is found, and the amount of demagnetization of the magnet corresponding to the found storage amount is obtained from the change amount table, the obtained amount of demagnetization of the magnet and a driving force Bl(x) when a magnetomotive force of the magnet decreases from the initial value are estimated as the current driving force Bl(x).

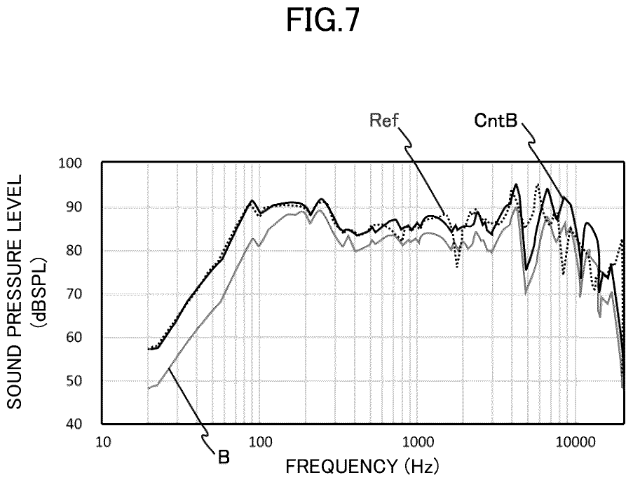

Since the driving force Bl(x) is proportional to the magnetomotive force of the magnet, the current driving force Bl(x) is found by reducing the driving force Bl(x) stored as the initial value of the parameter by the same percentage as the amount of demagnetization of the magnet. Here, FIG. 7 shows a specific example of the effect of the sound system as described above. In FIG. 7, a gray line B is the frequency characteristic of the sound pressure level at the sound receiving point M of the speaker 2 having a diameter of 10 cm when the sound source output signal u(n) is directly output to the amplifier 4, a black solid line CntB is the frequency characteristic of the sound pressure level at the sound receiving point M of the speaker 2 having a diameter of 10 cm when the signal processing unit 6 performs the above control, and the dotted line Ref is the frequency characteristic of the sound pressure level at the sound receiving point M of the speaker 2 having a diameter of 17 cm when the sound source output signal u(n) is directly output to the amplifier 4.

As shown in the figure, when the sound source output signal u(n) is directly output to the amplifier 4 in the low range of 100 Hz or less, the sound pressure level B of the speaker 2 having a diameter of 10 cm is smaller than the sound pressure level Ref of the speaker 2 having a diameter of 17 cm by about 10 dBSPL, while the difference between the sound pressure level CntB when the signal processing unit 6 performs the control described above for the speaker 2 having a diameter of 10 cm and the sound pressure level Ref of the speaker 2 having a diameter of 17 cm is within approximately 1 dBSPL.

Therefore, it can be shown from FIG. 7 that the sound pressure level in the low range can be increased without increasing the diameter of the speaker 2 according to the present embodiment. Thus, the embodiment of the present invention has been explained. As described above, according to the present embodiment, the equivalent circuit of the speaker 2 is calculated so as to conform to the measured displacement of the vibration of the speaker 2, and the inverse transfer characteristic G⁻ is set so as to follow the calculated equivalent circuit. In addition, at each time point, the equivalent circuit of the speaker 2 is updated so as to conform to the measured displacement of the vibration of the speaker 2, the impedance of the speaker 2, or the accumulated amount of the state of the temperature of the speaker 2, and the inverse transfer characteristic G⁻ is updated so as to follow the updated equivalent circuit. Therefore, the correction of the output characteristic of the speaker 2 to the target output characteristic can be made to conform to the actual transfer characteristic of each speaker 2 at each time point, and as a result, the correction can be made with high accuracy.

What is claimed is:

1. A speaker output characteristic correction system for correcting an output characteristic of a speaker with respect to an audio signal output from a sound source device, comprising:
a filter configured to supply to the speaker an output obtained by applying a set filter transfer characteristic to the audio signal output from the sound source device;
a transfer characteristic setting unit configured to set a filter transfer characteristic of the filter; and
a displacement detection unit configured to detect a displacement of a vibration of the speaker,
wherein the transfer characteristic setting unit is configured to set a transfer characteristic realizing an inverse transmission characteristic and a target transmission characteristic as the filter transfer characteristic of the filter, the inverse transmission characteristic being an inverse of base transmission characteristic, and the base transmission characteristic being a transmission characteristic from the audio signal to an acoustic signal value that is observed at a sound receiving point when the audio signal output from the sound source device is directly used as an output of the filter, the sound receiving point being predetermined,
wherein the target transfer characteristic is such that an acoustic signal value having a target acoustic signal characteristic is observed at the sound receiving point by using the target transfer characteristic as a transfer characteristic from the audio signal to an acoustic signal value at the sound receiving point when the audio signal output from the sound source device is directly used as an output of the filter, and
wherein the transfer characteristic setting unit is configured to determine a parameter of an equivalent circuit of the speaker based on a response of the displacement detected by the displacement detection unit to the audio signal output from the sound source device, calculate the inverse transfer characteristic according to the equivalent circuit having the determined parameter, and set a transfer characteristic realizing the calculated inverse transfer characteristic and the target transfer characteristic as the filter transfer characteristic of the filter.

2. The speaker output characteristic correction system according to claim 1, further comprising a transfer characteristic updating unit configured to update the filter transfer characteristic of the filter, wherein the transfer characteristic updating unit is configured to detect a change in the parameter of the equivalent circuit of the speaker based on the displacement detected by the displacement detection unit, update the inverse transfer characteristic according to the detected changed parameter, and update the filter transfer characteristic of the filter to the transfer characteristic realizing the updated inverse transfer characteristic and the target transfer characteristic.

3. The speaker output characteristic correction system according to claim 1, further comprising:
a transfer characteristic updating unit configured to update the filter transfer characteristic of the filter; and
an input detection unit configured to detect an input current and an input voltage of the speaker,
wherein the transfer characteristic updating unit is configured to detect a change in the parameter of the equivalent circuit of the speaker based on an impedance of the speaker found from the input current and the input voltage detected by the input detection unit, update the inverse transfer characteristic according to the equivalent circuit having a detected changed parameter, and update the filter transfer characteristic of the filter to the transfer characteristic realizing the updated inverse transfer characteristic and the target transfer characteristic.

4. A speaker output characteristic correction system for correcting an output characteristic of a speaker with respect to an audio signal output from a sound source device, comprising:
a filter configured to supply to the speaker an output obtained by applying a set filter transfer characteristic to the audio signal output from the sound source device;
a transfer characteristic updating unit configured to update a filter transfer characteristic of the filter; and
a displacement detection unit configured to detect a displacement of a vibration of the speaker,
wherein the filter transfer characteristic is a transfer characteristic realizing an inverse transmission characteristic and a target transmission characteristic, the inverse transmission a base characteristic being an inverse of transmission characteristic, and the base transmission characteristic being a transmission characteristic from the audio signal to an acoustic signal value that is observed at a sound receiving point when the audio signal output from the sound source device is directly used as an output of the filter, the sound receiving point being predetermined,
wherein the target transfer characteristic is such that the acoustic signal value having a target acoustic signal characteristic is observed at the sound receiving point by using the target transfer characteristic as a transfer characteristic from the audio signal to an acoustic signal value at the sound receiving point when the audio signal output from the sound source device is directly used as an output of the filter, and
wherein the transfer characteristic updating unit is configured to detect a change in a parameter of an equivalent circuit of the speaker based on the displacement detected by the displacement detection unit, update the inverse transfer characteristic according to the equivalent circuit having a detected changed parameter, and update the filter transfer characteristic of the filter to the transfer characteristic realizing the updated inverse transfer characteristic and the target transfer characteristic.

5. A speaker output characteristic correction system for correcting an output characteristic of a speaker with respect to an audio signal output from a sound source device, comprising:
a filter configured to supply to the speaker an output obtained by applying a set filter transfer characteristic to the audio signal output from the sound source device;
a transfer characteristic updating unit configured to update a filter transfer characteristic of the filter; and
an input detection unit configured to detect an input current and an input voltage,
wherein the filter transfer characteristic is a transfer characteristic realizing an inverse transmission characteristic and a target transmission characteristic, the inverse transmission characteristic being an inverse of a base transmission characteristic, and the base transmission characteristic being a transmission characteristic from the audio signal to an acoustic signal value that is observed at a sound receiving point when the audio signal output from the sound source device is directly used as an output of the filter, the sound receiving point being predetermined,
wherein the target transfer characteristic is such that an acoustic signal value having a target acoustic signal characteristic is observed at the sound receiving point by using the target transfer characteristic as a transfer characteristic from the audio signal to an acoustic signal value at the sound receiving point when the audio signal output from the sound source device is directly used as an output of the filter, and
wherein the transfer characteristic updating unit is configured to detect a change in a parameter of an equivalent circuit of the speaker based on an impedance of the speaker found from the input current and the input voltage detected by the input detection unit, update the inverse transfer characteristic according to the equivalent circuit having the detected changed parameter, and update the filter transfer characteristic of the filter to the transfer characteristic realizing the updated inverse transfer characteristic and the target transfer characteristic.

6. The speaker output characteristic correction system according to claim 1, wherein the target acoustic signal characteristic is a sound pressure level frequency characteristic, and the acoustic signal value is a sound pressure level.

7. The speaker output characteristic correction system of claim 6, wherein the base transfer characteristic, which is the transfer characteristic from the audio signal to the sound pressure level that is the acoustic signal value at the sound receiving point, is a transfer characteristic determined by a function configured to determine a relation between the transfer characteristic from the audio signal to the displacement of the vibration of the speaker found by the equivalent circuit of the speaker and the displacement of the vibration of the speaker and the sound pressure level at the sound receiving point.

8. The speaker output characteristic correction system according to claim 6, wherein the sound pressure level frequency characteristic, which is the target acoustic signal characteristic, is a frequency characteristic in which the sound pressure level at the sound receiving point is larger than when the audio signal output from the sound source device is directly used as an output of a filter in a low range.

9. The speaker output characteristic correction system according to claim 8, wherein the transfer characteristic setting unit is configured to calculate the target transfer characteristic by using the equivalent circuit obtained by modifying the equivalent circuit having the determined parameter so as to reduce an impedance, as the equivalent circuit of a virtual speaker in which an acoustic signal value having the target acoustic signal characteristic is obtained at the sound receiving point, and set a transfer characteristic realizing the calculated inverse transfer characteristic and the target transfer characteristic as the filter transfer characteristic of the filter.

10. An acoustic system comprising the speaker output characteristic correction system of claim 1, the speaker, and the sound source device.
